(19) United States
(12) Patent Application Publication
(10) Pub. No.: US 2025/0312221 A1
(43) Pub. Date: Oct. 9, 2025

(54) HEADREST FOR POSITIONING A PERSON'S HEAD IN PREPARATION FOR A TREATMENT AND METHOD OF USE THEREOF

(71) Applicant: Neuro Spinal Innovation Inc., Mississauga (CA)

(72) Inventor: Aslam Khan, Mississauga (CA)

(21) Appl. No.: 18/923,263

(22) Filed: Oct. 22, 2024

(30) Foreign Application Priority Data
Apr. 3, 2024 (CA) 3234051

(51) Int. Cl. A61G 13/12

(52) U.S. Cl. CPC A61G 13/121; A61G 13/129; A61G 13/1295

(57) ABSTRACT

A headrest is provided for positioning a patient's head and neck, the headrest comprising: a base; an actuating block which includes a housing which is mounted on the base and an elevator which is vertically slidably engaged with the housing and includes a vertical actuating mechanism and a tilt actuating mechanism; a first arm and a second arm which are attached to the elevator; a platform which is hingedly connected to the tilt actuating mechanism; a first pivot mount and a second pivot mount which are attached to or are part of the platform and are pivotally attached to the first arm and the second arm, respectively; and a landmark cushion which is mounted on the platform, includes a lateral midline and a distal end and defines a central aperture, wherein the first pivot mount and the second pivot mount are aligned with the lateral midline.

### CROSS REFERENCE TO RELATED APPLICATIONS

The present application claims benefit of Canadian Patent Application Serial No. 3234051, filed on Apr. 3, 2024, entitled HEADREST FOR POSITIONING A PERSON'S HEAD IN PREPARATION FOR A TREATMENT AND METHOD OF USE THEREOF, the contents of which are incorporated herein by reference.

### FIELD

The present technology is related to a headrest that is designed to allow a patient to self-position themselves in preparation for a treatment. More specifically, it is a headrest that includes a base, a platform and a landmark cushion and has an actuating block for adjustment of height and tilt, allowing for accurate positioning of the patient's head.

### BACKGROUND

There are many treatments that require accurate positioning of a user or patient's head. For example, in chiropractic treatments, surgery, acupuncture and needling. Other treatments such as massage therapy, physiotherapy and athletic therapy, to name a few, could benefit from accurate positioning. For this reason, there are numerous headrests and head restraints in the literature. For example, United States Patent Application Publication No. 20040017099 discloses an articulated headrest. In one embodiment, an apparatus includes a base portion and a headrest portion, and the headrest portion is coupled to the base portion by an articulation mechanism which moves the headrest substantially along an arc defined with respect to a pivot point outside the headrest portion and the base portion. In some embodiments, the pivot point may approximate the cervicothoracic junction of a user. In some embodiments, the headrest portion may be used to maintain the user's head in a substantially neutral position. In some embodiments, the headrest portion may be deployed in the event of a crash condition and/or may articulate in response to reclining a seat back. In one embodiment, a portable or pillow version may articulate a headrest portion with respect to a base portion to provide head support. This headrest is best suited for use in a vehicle and therefore is designed for such an application. It is not designed to accurately position a patient or user's head in preparation for a treatment.

United States Patent Application Publication No. 20020170116 discloses a surgical table apparatus for supporting a patient before, during, or after a surgical procedure. The surgical table apparatus includes a base and a tabletop. The tabletop includes a body support section adapted to support the body of a patient and a head support section adapted to support the head of a patient. The head support section is not designed to accurately position a patient or user's head in preparation for a treatment.

United States Patent Application Publication No. 20150283018 discloses an adjustable device that provides support and stabilization for a patient's head during surgical procedures, especially ophthalmologic ones. A frame, including a base and lateral panel, allows an adjustable lateral support and locking mechanism to be engaged with each other and the frame. The adjustable lateral support consists of an elongated member, which is placed through a hole of the lateral panel, and a connected head bracing structure. A first cushioning pad and a second cushioning pad are secured to the base and the head bracing structure, respectively. The locking mechanism uses a spring which pushes a handle against the elongated member. The elongated member traverses through a slot of the handle; when the handle is pressed against the elongated member, the slot applies pressure against the elongated member and prevents movement. The handle can be lifted to allow the elongated member and thus head bracing structure to be repositioned. The head support section is not designed to accurately position a patient or user's head in preparation for a treatment.

United States Patent Application Publication No. 20150054326 discloses a headrest assembly for a chair that includes a headrest unit, two spaced-apart grip frame members respectively connected to two opposite ends of the headrest unit, and two spaced-apart connection frame members respectively connected to the grip frame members. The grip frame members gradually extend away from each other from the headrest unit to the connection frame members, respectively. Each of the grip frame members extends obliquely, rearwardly and downwardly from the headrest unit in a manner of being oblique to a first vertical plane that has opposite front and rear surfaces respectively facing front and rear sides of the chair. The headrest is minimally adjustable. The headrest is not designed to accurately position a patient or user's head in preparation for a treatment.

United States Patent Application Publication No. 20140145488 discloses an improved adjustable chair headrest. Specifically, the present invention comprises a double articulating dental chair headrest apparatus which has a one-handed side pushbutton release and locking mechanism. When pressed, the pushbutton temporarily disengages a movable mating plate having splined perforations away from each of two corresponding rotatable splined pin assemblies to unlock each splined pin assembly. The unlocked splined pin assemblies each rotate independently. Each splined pin assembly is also fixedly attached to one of a headrest and a backrest via an attachment plate. The two splined pin assemblies are held in relation to each other, the movable mating plate having splined perforations, and the side pushbutton release and locking mechanism, by a housing component. The headrest is independent of the dentist chair and can be rotated to help position the patient's head. However, the headrest is minimally adjustable and is not designed to accurately position a patient or user's head in preparation for a treatment.

United States Patent Application Publication No. 20140096322 discloses a headrest assembly that includes a frame, a first head support configured and dimensioned to support a forehead of a patient, and a second head support configured and dimensioned to support a chin of the patient. An adjustment mechanism is mounted to the frame and is operable to adjust the position of at least one of the first and second head supports relative to the frame. The first and second head supports having at least two degrees of freedom relative to a longitudinal plane and at least one degree of freedom relative to an axial plane that is orthogonal to the longitudinal plane. The longitudinal plane extends parallel to an X axis and also extends parallel to a Y axis that is orthogonal to the X axis. The axial plane extends parallel to one of the X axis and the Y axis. The axial plane also extends parallel to a Z-axis that is orthogonal to both the X axis and the Y axis. While these head supports can be adjusted, they are overly complex and could result in the patient's head being improperly placed as the two head supports can be adjusted individually.

United States Patent Application Publication No. 20050184573 discloses a mechanism for supporting and permitting selected adjustment of the position of a headrest relative to the back of a chair comprises a body, a first pivotable connection, a second pivotable connection and a selectively releasable locking mechanism. The first pivotable connection is near the first end of the body, adapted to connect to the chair and to allow pivoting of the body relative to the chair. The second pivotable connection is near the second end of the body, adapted to connect to the headrest and to allow pivoting of the headrest relative to the body. The selectively releasable locking mechanism is configured to retain the body in selected angular positions relative to the chair and relative to the headrest by clamping together interleaved plate members in frictional contact and to allow for one-handed actuation. The adjustment is limited therefore the headrest and mechanism are not designed to accurately position a patient or user's head in preparation for a treatment.

Canadian Patent No. 2636592 discloses devices, systems, and methods to support and/or restrain a head of a patient, optionally for use in refractive surgery. Both the height of the patient's head and the angle of the patient's neck along the medial-lateral plane of the patient can be established independently, and compression pillow systems can gently and atraumatically compress the patient's head between protruding foam sidewalls or the like to inhibit movement of the patient from the alignment position. The system is for restraining the patient's head and is not designed to accurately position a patient or user's head in preparation for a treatment.

U.S. Pat. No. 4,649,905 discloses a headpiece and headpiece coupling arrangement to be used in conjunction with a chiropractic treatment table, allowing the practitioner to select any one or more of five different modes of movement of the headrest relative to the main portion of the treatment table. In addition to the somewhat conventional pivotal motion about a horizontal axis the present invention provides the practitioner with pivotal motion about a vertical axis, linear extension or traction, rotation of the headpiece about a longitudinal axis coinciding with the patient's spinal column and an abrupt limited motion for bringing a patient's head forward and downwardly, imparting a snapping action to the cervical spine portion. This is for use as a treatment device and is not designed to accurately position a patient or user's head in preparation for a treatment.

United States Patent Application Publication No. 20020169460 discloses a head support apparatus. The apparatus may for example be used for ophthalmic examination. In some embodiments, the apparatus may allow six degrees of freedom of motion during initial positioning of a patient's head, and may then be locked to hold the patient's head in place precisely. The head support mechanism may include three shafts connecting an upper frame to a structure. Each shaft may be provided with a ball-and-socket joint at one end and a lockable bearing assembly on the other end. The lockable bearing assembly may provide a combination of sliding and pivotal movement. A biasing assembly may be provided to support each shaft, and to return each shaft to a self-centered and fully lifted rest position. A head clamping apparatus is also disclosed comprising pivoting clamping arms and an adjustable chin rest. This head support is designed for the patient to be face down.

Chinese Patent No. 112843505 discloses a medical radiotherapy auxiliary positioning detector, and belongs to the technical field of diagnosis and treatment equipment, the medical radiotherapy auxiliary positioning detector comprises a base seat, a matching seat, an adjusting assembly and a headrest seat, the matching seat is installed at the bottom end of the side wall of the base seat, and the top end of the adjusting assembly is in contact with the headrest seat; the adjusting assembly comprises a supporting transverse plate, an adjusting cap, a jacking threaded column, a main supporting column, an extending arm, an auxiliary supporting column, a driving gear, a driving shaft and a driving rotary knob, the adjusting assembly can adjust the height and the angle of the headrest seat so as to meet different use requirements, the vertical height of the supporting transverse plate can be adjusted by screwing the adjusting cap, the angle of the headrest seat can be indirectly adjusted by rotating the driving knob; the auxiliary supporting column is limited through the extending arm; the whole device is convenient to disassemble and assemble and good in stability; and the headrest seat can be adjusted, so that a patient can obtain the optimal radiotherapy angle, and the whole device is simple and convenient in the process of adjusting the headrest seat and good in practicability. This headrest requires attachment to the treatment table. Only the height and angle of the headrest can be adjusted. It would not accurately position the patient's head and neck for a treatment.

European Patent No. 3416585 discloses a headrest for an immobilization system for immobilizing at least a part of a patient. The headrest includes a supporting structure and a sheet-like formed elastic panel attached to the supporting structure on at least two opposite sides of the elastic panel. The elastic panel is configured to support at least a part of a head and/or at least a part of a neck of a patient, wherein at least a part of the elastic panel is stretchable and configured to stretch when said at least part of the head and/or neck of the patient is arranged on the elastic panel, such that a shape of said at least part of the elastic panel is formed corresponding to a shape of said at least part of the head and/or neck of the patient. This is not adjustable and would not allow a patient's head and neck to be positioned for a treatment.

There are numerous patents directed to a headrest for use with a treatment chair. For example, Chinese Patent Publication No. 216496380 discloses a dental chair with the adjustable patient treatment position, one end of a lifting driving device arranged in a pitching part is connected with a seat cushion support provided with a cushion soft cushion, the other end of the lifting driving device is connected with a backrest bent plate in the pitching part, and the backrest bent plate is connected with a rotary supporting device arranged in a backrest part; the seat cushion support and the backrest part are controlled by the lifting driving device to adjust the pitching position of the patient, a lifting adjusting device arranged on the headrest part is connected with the upper end of the backrest part, and the height of the headrest part is adjusted through the lifting adjusting device. Motion compensation is formed between the seat frame and the backrest bent plate during pitching motion, and muscle fatigue of a patient during long-time treatment can be relieved at different treatment positions; the whole headrest part can slide up and down, so that the patient can adjust the height of the headrest in the diagnosis and treatment process, the optimal diagnosis and treatment position is found, and the comfort experience of the patient in the diagnosis and treatment process is improved. This headrest and others relating to dental chairs would not be suitable for positioning a patient's head and neck in preparation for a treatment.

What is needed is a headrest that allows for accurate positioning of a user's head and neck in relation to the rest of the body. It would be preferable if it assisted a patient in self-positioning. It would be preferable if it was adjustable. It would be preferable if it was a stand-alone apparatus. It would be preferable if it directed the patient to the proper alignment of their head and neck. It would be preferable if it was comfortable for the patient and did not clamp or otherwise restrain the user's head. It would be still further preferable if the headrest was of a low profile.

### SUMMARY

The present technology is a headrest that allows for accurate positioning of a user's head and neck in relation to the rest of the body. It also assists the patient to self-position, thereby reducing the time taken by the practitioner to adjust the patient before the practitioner can commence a treatment. The height and the tilt of the landmark cushion is adjustable. It is a stand-alone apparatus that can be placed on a treatment table. It is comfortable for the patient and does not clamp or otherwise restrain the user's head. The mechanical controls are distal to the landmark cushion and therefore distant from the patient. It has a low profile.

In one embodiment, a headrest is provided for positioning a patient's head and neck, the headrest comprising: a base; an actuating block which includes a housing which is mounted on the base, and an elevator which is vertically slidably engaged with the housing and includes a vertical actuating mechanism and a tilt actuating mechanism; a first arm and a second arm which are attached to the elevator; a platform which is hingedly connected to the tilt actuating mechanism; a first pivot mount and a second pivot mount which are attached to or are part of the platform and are pivotally attached to the first arm and the second arm, respectively; and a landmark cushion which is mounted on the platform, includes a lateral midline and a distal end and defines a central aperture, wherein the first pivot mount and the second pivot mount are aligned with the lateral midline.

In the headrest, the vertical actuating mechanism may include a gear actuator and at least one rack pair comprising a rack and a gear, wherein the gear actuator is in motive relation with the gear, and the rack is disposed on one of the housing or the elevator and the gear is rotatably disposed on the other of the housing or the elevator.

In the headrest, the rack may be disposed on the elevator and the gear may be rotatably mounted on the housing.

In the headrest, the tilt actuating mechanism may include a tilt actuator and an angle adjustment arm, wherein the tilt actuator is in motive relation with the angle adjustment arm and the angle adjustment arm is hingedly connected to the platform.

In the headrest, the actuating block may further comprise a plurality of rails and sliders, the rails are disposed on one of the housing or the elevator and the sliders are disposed on the other of the housing or the elevator.

The headrest may further comprise an outer housing which is connected to the elevator and is disposed outside of the housing.

In the headrest, the actuating block may be distal to a distal end of the landmark cushion.

In the headrest, the landmark cushion may releasably mounted on the platform.

In the headrest, the platform and the base may be U-shaped and the platform may nest in the base.

In another embodiment, a method of a patient self-aligning their head in preparation for a treatment is provided, the method comprising: selecting the headrest of as described above, which is located on a treatment table; the patient lying on the treatment table; and the patient locating their ear in the central aperture such that their tragus is aligned with the first pivot mount and the second pivot mount, the patient thereby self-aligning their head in preparation for the treatment.

In another embodiment, a method of positioning a patient's head and neck in preparation for a treatment is provided, the method comprising: selecting the headrest as described above, which is located on a treatment table; the patient lying on the treatment table; locating the patient's ear in the central aperture such that their tragus is aligned with the first pivot mount and the second pivot mount; actuating the gear actuator; and, concomitantly, the gear actuator adjusting the height of the platform and landmark cushion, thereby positioning the patient's head and neck.

The method may further comprise actuating the tilt actuator; and, concomitantly, the angle adjustment arm tilting the platform and the landmark cushion.

In the method, the positioning may be conducted by a practitioner.

In the method, the aligning the patient's tragus with the first pivot mount and the second pivot mount may be conducted by the patient.

In the method, the adjusting the height and the tilting of the platform and the landmark cushion may be conducted by a practitioner.

### FIGURES

FIG. 1 is a side perspective view of the headrest of the present technology.

FIG. 2A is a rear view of the headrest of FIG. 1; and FIG. 2B is a front view of the headrest of FIG. 1.

FIG. 3 is a side perspective view of the headrest of FIG. 1 with the outer housing and the landmark cushion removed.

FIG. 4A is a rear perspective view of the actuation block of the headrest of FIG. 1; FIG. 4B is a top view of the actuation block of the headrest of FIG. 1; and FIG. 4C is a side sectional view of the actuation block of the headrest of FIG. 1.

FIG. 5A is a side view of the headrest with the landmark cushion in an elevated position; and FIG. 5B is a side view of the headrest with the landmark cushion in an elevated and tilted position.

FIG. 6 is a top view of the headrest of FIG. 1.

FIG. 7 is a perspective view of a patient correctly positioned on the landmark cushion of the headrest of FIG. 1.

### DESCRIPTION

Except as otherwise expressly provided, the following rules of interpretation apply to this specification: (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

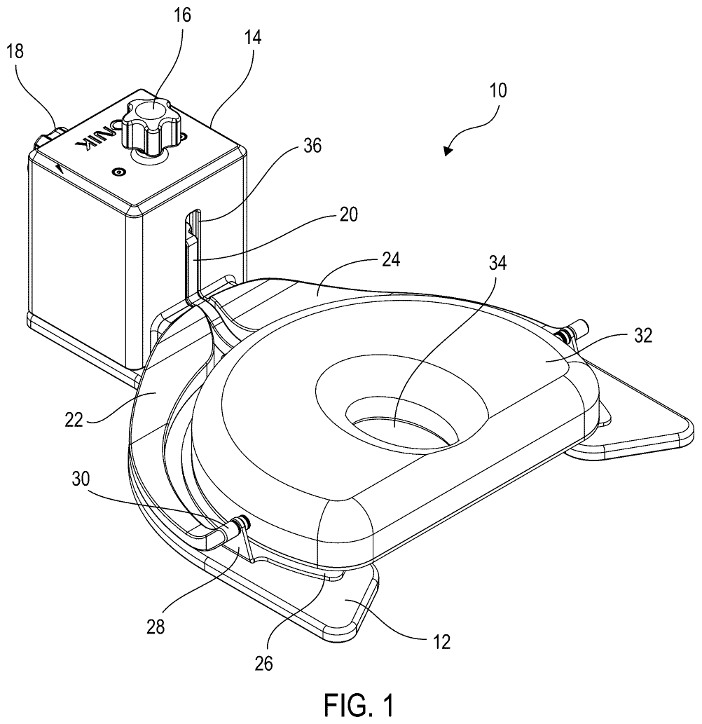

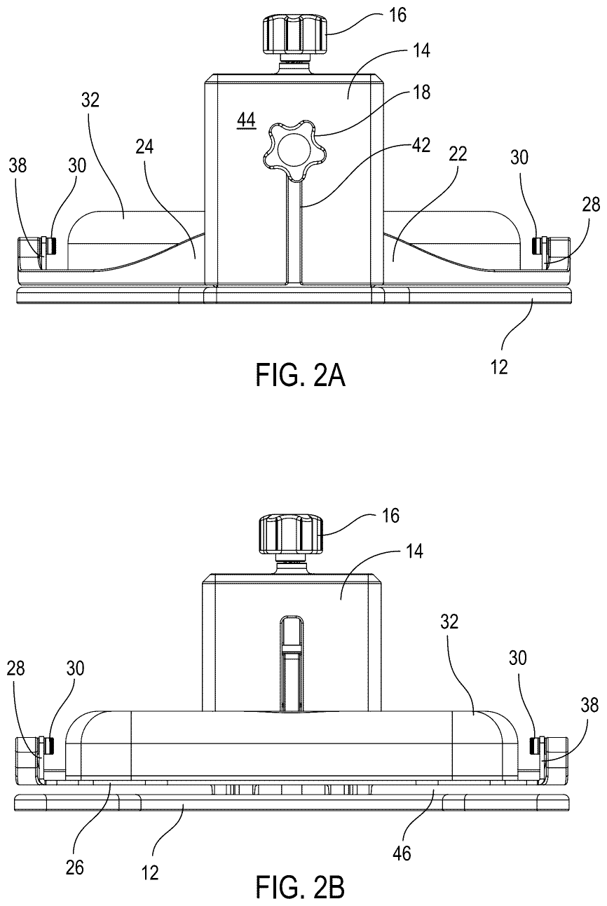

A headrest for positioning a patient's head and neck, generally referred to as 10, is shown in FIG. 1. It includes a base 12 for locating on a treatment table, an outer housing 14, a tilt adjustment knob 16, a height adjustment knob 18, an angle adjustment arm 20, a first arm 22, a second arm 24, a platform 26, a first pivot mount 28, a second pivot mount 38 (as shown in FIGS. 2A and B) a pair of pins 30 and a landmark cushion 32. The landmark cushion 32 defines a central aperture 34. In an alternative embodiment, the central aperture is replaced with a central cavity. The pivot mounts 28, 38 are mounted on the platform 26. In an alternative embodiment, the pivot mounts 28, 38 are integral with the platform 26. The angle adjustment arm 20 extends through a vertical slot 36 in the outer housing 14 and is attached to the platform 26. The headrest 10 is compact and has a low profile. It allows a patient to comfortably locate the side of their head such that their ear is in the central aperture 34.

As shown in FIG. 2A, the platform 26 is pivotally retained on the first arm 22 by the pin 30 and the pivot mount 28 on a first side, and on the second arm 24 by another pin 30 and the pivot mount 38 on a second side. There is a vertical slot 42 in the back 44 of the outer housing 14 through which the shaft which is attached to height adjustment knob 18 extends. As shown in FIG. 2B, in the storage position, there is a small horizontal gap 46 between the base 12 and the platform 26 to allow slight tilting movement of the platform 26 before vertical movement.

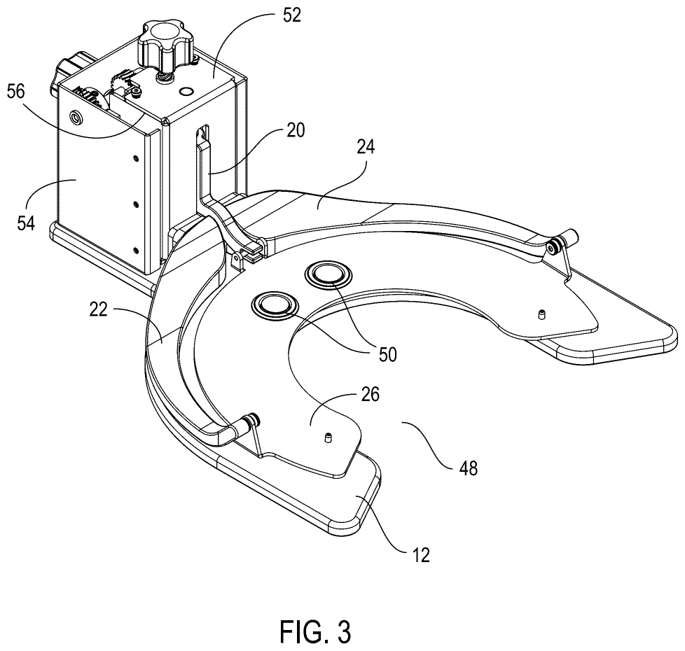

As shown in FIG. 3, the base 12 and the platform 26 are horseshoe-shaped and the platform 26 is nested in the opening 48 of the base 12. This allows for the platform 26 to tilt and, when not in use, to provide a low profile. In an alternative embodiment, the platform 26 is round or ovoid and includes a central aperture. A pair of magnets 50 are attached to the platform 26 to allow for easy removal and replacement of the landmark cushion 32, which includes a metal frame. In an alternative embodiment, other attachment pairs are included for easy removal and replacement, for example, but not limited, hook and loop attachment pairs. The arms 22, 24 are attached to an elevator 52.

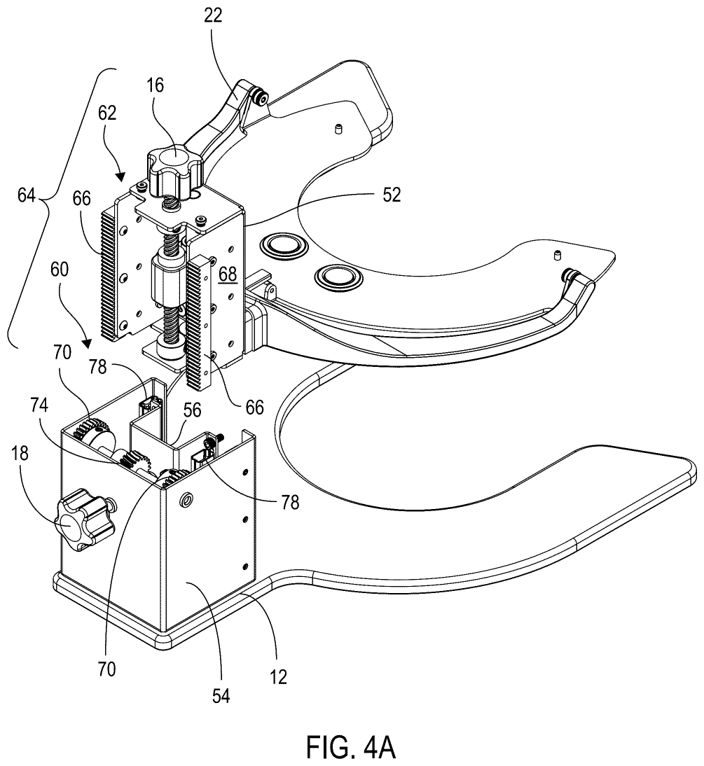

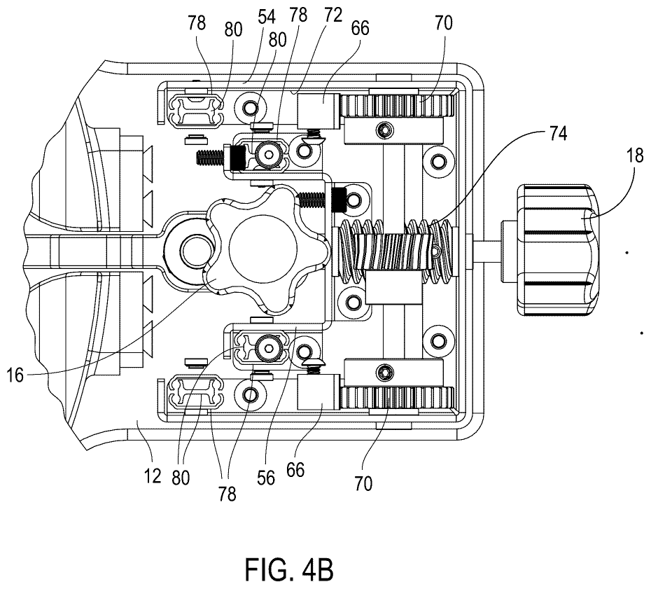

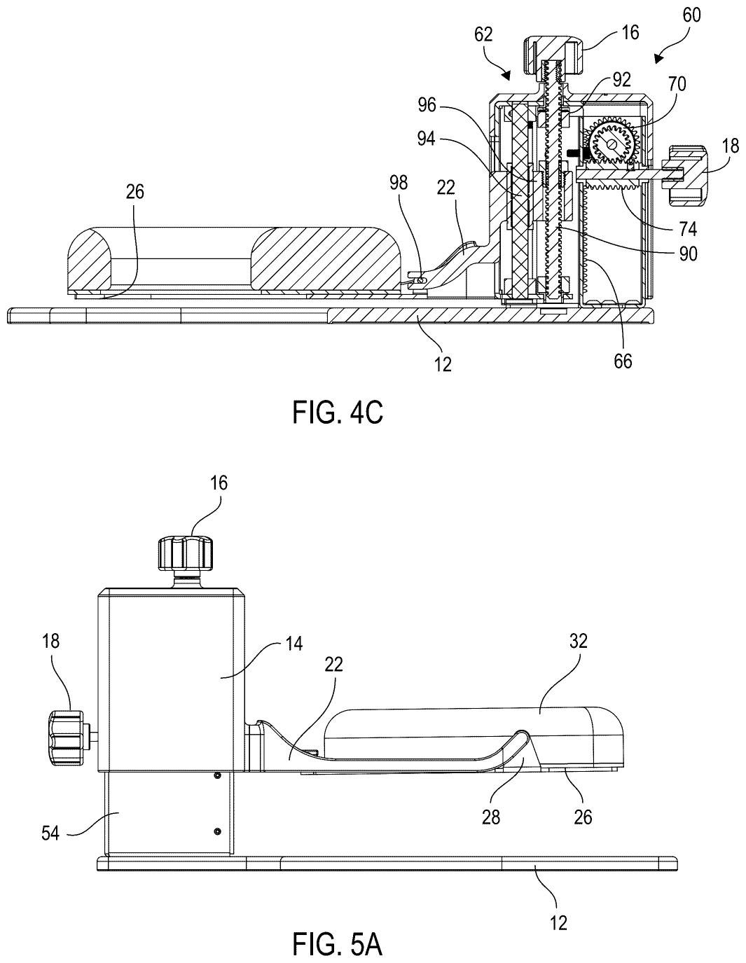

FIGS. 4A-C shows the vertical actuating mechanism, generally referred to as 60 and the tilt actuating mechanism, generally referred to as 62, collectively referred to as the actuating block 64. In FIGS. 4A and B the outer housing 14 has been removed. The elevator 52 is in slidable engagement with a middle housing 54 and an inner housing 56. The middle housing 54 and the inner housing 56 are affixed to the base 12.

The elevator 52 has two racks 66 mounted on the outer surface 68. Two gears 70 that mesh with the racks 66 are mounted on the inner surface 72 of the middle housing 54. The gears 70 are driven by a worm gear 74 which is actuated by the vertical adjustment knob 18. The middle housing 54, which is U-shaped, has two rails 78 mounted on an inner surface. The inner housing 56 has an additional two rails 78 that are mounted on an outer surface. The elevator 52 has sliders 80 that are in slidable engagement with the rails 78. In an alternative embodiment, the inner housing 56 is not present and the middle or second housing 56 retains all four rails 78.

Referring to FIGS. 4A and C, the tilt actuating mechanism 62 is part of the elevator 52 but acts independently from the vertical actuating mechanism 60. A threaded member 90 is threadedly engaged to a female threaded member 92 and is attached to a rod 94 by a fitting 96. The rod 94 is attached to the angle adjustment arm 20. A hinge 98 at the distal end of the angle adjustment arm 20 hingedly attaches the platform 26. To be clear, the base 12 and the platform 26, while shown in these figures, are not part of the actuating block 64.

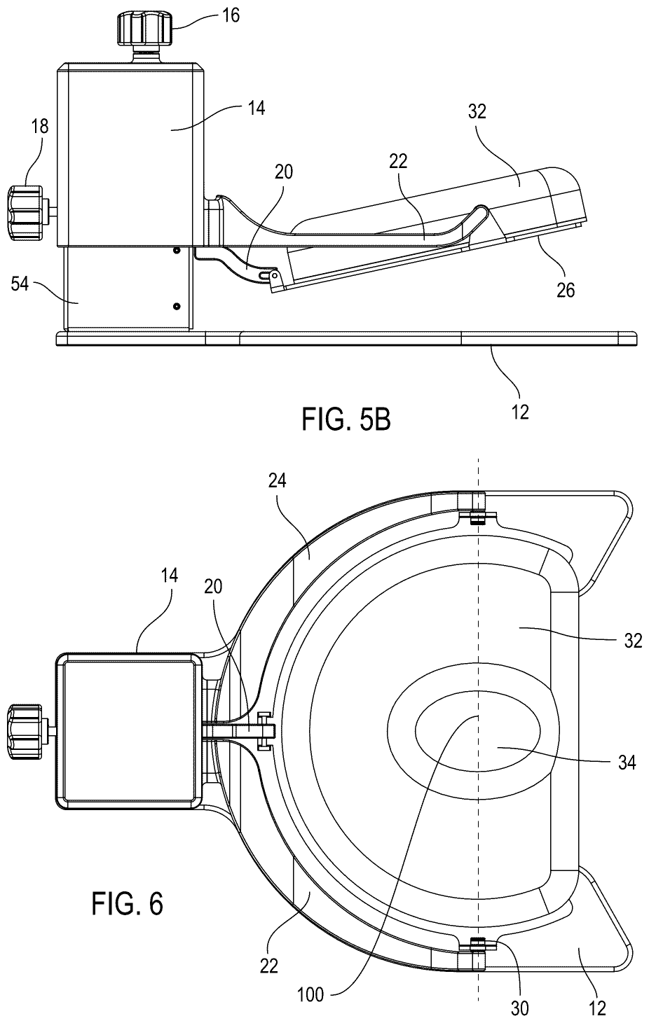

As can be understood from FIG. 5A, the outer housing 14 is attached to the elevator 52. Thus, when the elevator 52 is raised or lowered, the outer housing 14 is also raised and lowered. The angle adjustment arm 20 holds the platform 26 in the horizontal position, as the tilting actuating mechanism 62 is not actuated. In FIG. 5B, both the vertically actuating mechanism 60 and the tilt actuating mechanism 62 have been actuated.

It was found through measuring hundreds of patients, that the distance from the tragus to the top of the ear varies by about ½ centimeter. Accordingly, by aligning the pins 30 with the lateral midline 100 of the landmark cushion 32, as shown in FIG. 6, it was found that if a patient positioned their head such that their ear was in the central aperture 34, the tragus was aligned with the pivot mounts 28, 38 and more specifically the pins 30 that are located in the pivot mounts 28, 38. As the tragus is the treatment location for alignment of the atlas of the cervical vertebrae, the practitioner need only adjust the vertical position and optionally the angle of the landmark cushion 32 to position the head and neck before commencing a treatment, noting that angling of the landmark cushion 32 extends the cervical vertebrae and assists in adjusting the position of the atlas (C1). Hence, the headrest 10 allows for the patient to self-align their head, leaving only the positioning to the practitioner. In prior art headrests, the practitioner had to spend considerable time aligning the patient's head in the headrest.

Once the head is aligned such that the tragus is aligned with the first and second pivot mounts 28, 38, the gear actuator is actuated causing the concomitant adjustment of the height of the platform 26 and the landmark cushion 32. If the angle of the platform 26 and the landmark cushion 32 needs to be changed, the tilt actuator is actuated causing the concomitant tilting of the platform 26 and the landmark cushion 32 by the angle adjustment arm 20.

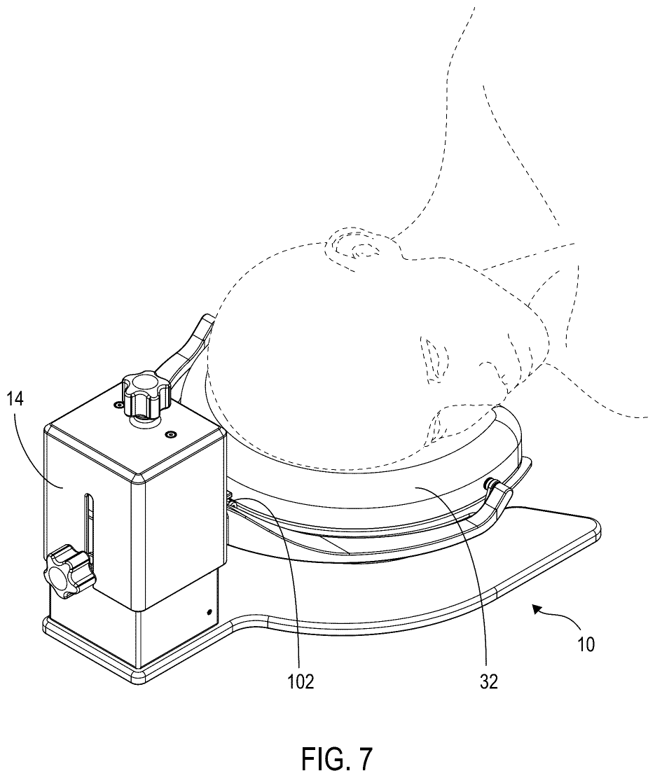

A patient is shown with their head properly aligned on the headrest 10 in FIG. 7. It can be seen that the outer housing 14 which covers the actuating block 64, is distal to the distal end 102 of the landmark cushion 32. Thus, the mechanical controls are distant to the patient.

The headrest 10 is designed to support the user's head both in a face down position and in a face to the side position. The ear of the user should be located in the central aperture 34 or central depression when the user is on their side. The landmark of interest in one embodiment is the ear, and more specifically the tragus.

The following is a list of the functions of the headrest 10:
Position patient's head and neck in preparation for a treatment;
Patient positions self in preparation for a treatment by learning to align the tragus with the pin 30 and pivot mounts 28, 38 or pins 30;
Support head during treatment to the cervical (C) spine, and C1 region;
Support head when patient is face down for other bodily treatments;
Pivot head using tragus as pivot point; and
Provide tragus adjustments of 0.5 cm increments within a ±3 cm range.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A headrest for positioning a patient's head and neck, the headrest comprising:
a base; an actuating block which includes a housing which is mounted on the base and an elevator which is vertically slidably engaged with the housing and includes a vertical actuating mechanism and a tilt actuating mechanism; a first arm and a second arm which are attached to the elevator; a platform which is hingedly connected to the tilt actuating mechanism; a first pivot mount and a second pivot mount which are attached to or are part of the platform and are pivotally attached to the first arm and the second arm, respectively; and a landmark cushion which is mounted on the platform, includes a lateral midline and a distal end and defines a central aperture, wherein the first pivot mount and the second pivot mount are aligned with the lateral midline.

2. The headrest of claim 1, wherein the vertical actuating mechanism includes a gear actuator and at least one rack pair comprising a rack and a gear, wherein the gear actuator is in motive relation with the gear, and the rack is disposed on one of the housing or the elevator and the gear is rotatably disposed on the other of the housing or the elevator.

3. The headrest of claim 2, wherein the rack is disposed on the elevator and the gear is rotatably mounted on the housing.

4. The headrest of claim 3, wherein the tilt actuating mechanism includes a tilt actuator and an angle adjustment arm, wherein the tilt actuator is in motive relation with the angle adjustment arm and the angle adjustment arm is hingedly connected to the platform.

5. The headrest of claim 4, wherein the actuating block further comprises a plurality of rails and sliders, the rails disposed on one of the housing or the elevator and the sliders disposed on the other of the housing or the elevator.

6. The headrest of claim 5, further comprising an outer housing which is connected to the elevator and is disposed outside of the housing.

7. The headrest of claim 6, wherein the actuating block is distal to a distal end of the landmark cushion.

8. The headrest of claim 7, wherein the landmark cushion is releasably mounted on the platform.

9. The headrest of claim 8, wherein the platform and the base are U-shaped and the platform is nested in the base.

10. A method of a patient self-aligning their head in preparation for a treatment, the method comprising: selecting the headrest of claim 1, which is located on a treatment table; the patient lying on the treatment table; and the patient locating their ear in the central aperture such that their tragus is aligned with the first pivot mount and the second pivot mount, the patient thereby self-aligning their head in preparation for the treatment.

11. A method of positioning a patient's head and neck in preparation for a treatment, the method comprising: selecting the headrest of claim 4, which is located on a treatment table; the patient lying on the treatment table; locating the patient's ear in the central aperture such that their tragus is aligned with the first pivot mount and the second pivot mount; actuating the gear actuator; and, concomitantly, the gear actuator adjusting the height of the platform and landmark cushion, thereby positioning the patient's head and neck.

12. The method of claim 11, further comprising actuating the tilt actuator; and, concomitantly, the angle adjustment arm tilting the platform and the landmark cushion.

13. The method of claim 11, wherein the positioning is conducted by a practitioner.

14. The method of claim 11, wherein the aligning the patient's tragus with the first pivot mount and the second pivot mount is conducted by the patient.

15. The method of claim 12, wherein the positioning is conducted by a practitioner.

16. The method of claim 12, wherein the aligning the patient's tragus with the first pivot mount and the second pivot mount is conducted by the patient.

17. The method of claim 14, wherein the adjusting the height and the tilting of the platform and the landmark cushion are conducted by a practitioner.
